(19) United States
(12) Patent Application Publication
(10) Pub. No.: US 2003/0138678 A1
(43) Pub. Date: Jul. 24, 2003

(54) Method for mixing fuel in water, associated device, and implementation of the mixing device

(76) Inventor: Walter Preidel, Erlangen (DE)

Correspondence Address: LERNER AND GREENBERG, P.A., Post Office Box 2480, Hollywood, FL, 33022-2480, US

(21) Appl. No.: 10/368,157

(22) Filed: Feb. 18, 2003

Related U.S. Application Data
(63) Continuation of application No. PCT/DE01/02979, filed on Aug. 3, 2001.

(30) Foreign Application Priority Data
Aug. 16, 2000 (DE) 100 40 084.1

(51) Int. Cl. H01M 8/04

(52) U.S. Cl. 429/13; 429/24; 429/25; 239/398

(57) ABSTRACT

To ensure a performance-based regulation of a fuel cell, the use of fuel-mixtures with a defined flow is required. Mixtures of this type are formed by pumping water through a hollow body, which, at least in certain sections, has a wall formed of porous material. The fuel is pumped into a chamber on the other side of the porous wall, at a defined flow rate. As a result of the pressure difference, the fuel permeates the porous wall over its entire surface into the water flowing past on the other side of said porous wall, thus creating a homogeneous mixture. In the corresponding device, at least certain segments of the hollow body have a porous wall. A device of this type is preferably used in direct methanol fuel cells, for which the operating temperature and the operating pressure can be predefined.

### CROSS-REFERENCE TO RELATED APPLICATION

This application is a continuation of copending International Application No. PCT/DE01/02979, filed Aug. 3, 2001, which designated the United States and which was not published in English.

### BACKGROUND OF THE INVENTION

### Field of the Invention

The invention relates to a method for mixing a fuel in water, in particular for use in a fuel cell. In addition, the invention also relates to the associated device that is configured to carry out the process, having a body through which water is pumped. In the invention, the fuel is preferably, although not exclusively, methanol.

Fuel cells are operated with liquid or gaseous fuels. If the fuel cell operates with hydrogen, a hydrogen infrastructure or a reformer for generating the gaseous hydrogen from the liquid fuel is required. Examples of liquid fuels are gasoline, ethanol or methanol. What is known as a DMFC (direct methanol fuel cell) operates directly with methanol as its fuel. The function and status of DMFCs are described in detail by the inventor in “VIK-Berichte”, No. 214 (November 1999), pp. 55-62.

For appropriate control and power-dependent regulation of the direct methanol fuel cell (DFFC), it is necessary to continuously produce a water/methanol mixture, which is dependent on the load on the fuel cell, with a defined flow rate. The mixture is used as both fuel and electrolyte for the process which determines DMFCs, and the proportions in the mixture have to be quantitatively predetermined and then maintained. Simple injection of the methanol into a flow of water is not suitable for this purpose, since the mixing should take place at the minimum possible distance from the cell or cells, in order to keep the dead volume as small as possible, so that the control path becomes as fast as possible.

Furthermore, it is desirable for the water to be at approximately the operating temperature of the fuel cell, so that pronounced temperature gradients in the fuel cell do not lead to nonuniform conversion. This is not acceptable, in particular on account of the formation of carbon dioxide. If the fuel circuit of the fuel cell is simultaneously used for cooling, for this reason the entry temperature should nevertheless be selected to be as high as possible and cooling should tend to be on the cathode side as a result of the evaporation of water and subsequent condensation in a condenser or heat exchanger.

Since the standard operating temperatures of a DMFC are above the boiling point of methanol, i.e., even in spite of possible higher operating pressures, simple injection of methanol into water at temperatures of from 80° C. to, for example, 160° C. leads to the formation of vapor bubbles which are only broken down slowly in the flow of liquid. It is therefore necessary to achieve intimate mixing of water and methanol without the methanol forming vapor bubbles.

It is known from international publication WO 99/44250 A1 to produce a methanol/water mixture by injection. However, sufficient mixing of the methanol and water for the specific application is not ensured in that way.

### SUMMARY OF THE INVENTION

It is accordingly an object of the invention to provide a method of mixing a fuel (e.g., methanol) with water, a corresponding mixing device, and an implementation of the process, which overcomes the above-mentioned disadvantages of the heretofore-known devices and methods of this general type and which achieves intensive mixing of fuel and water.

With the foregoing and other objects in view there is provided, in accordance with the invention, a mixing method, preferably for mixing fuel of a fuel cell, which comprises the following steps:

pumping water through a hollow body having a porous wall formed of porous material, at least in certain regions thereof;

pumping a fuel at a defined flow rate into a space on a side of the porous wall opposite from the water;

wherein a pressure difference between the two sides of the porous wall causes the fuel to penetrate into the water on the opposite side of the porous wall substantially over an entire surface area of the porous wall; and

producing a homogenous mixture of water and fuel substantially without bubble formation.

In accordance with a preferred embodiment of the invention, the fuel is methanol.

In accordance with an added feature of the invention, the mixture of water and methanol is pumped through a constriction for generating a turbulent flow and improving an intimate mixing of the mixture.

In accordance with an additional feature of the invention, a temperature and/or a pressure of the methanol/water mixture can be adjusted by predetermining a pore size of the porous material.

In accordance with another feature of the invention, small pores are selected for high temperatures and low pressures of the methanol/water mixture and large pores are selected for high pressures and low temperatures of the methanol/water mixture.

With the above and other objects in view there is also provided, in accordance with the invention, a device for mixing a fuel and water, specifically for carrying out the method outlined above. The device comprises:

a hollow body formed with an inside for receiving and having water pumped therethrough, said hollow body being formed, at least in a part thereof, with a porous wall; and

a further wall externally delimiting a region of the porous wall and forming a closed space fluidically communicating with the inside of said hollow body through the porous wall.

In accordance with a further feature of the invention, the porous wall has a porosity greater than 0.1 μm, preferably between 0.2 μm and 10 μm.

In accordance with two preferred implementations, the hollow body with the porous wall is a tube or it is a cylinder.

It is further advantageous if the porous wall is a ceramic tube segment forming a part of the tube.

Preferably, also, the porous wall is a metallic glass filter and/or consists of glass material and/or contains commercial glass or ceramic filters.

The device is particularly suitable for carrying out the above-summarized method in a fuel cell at temperatures which are higher than the boiling point of the fuel.

In a particularly preferred embodiment, the fuel is methanol and the fuel cell is a direct methanol fuel cell (DMFC).

In accordance with a concomitant feature of the invention, the operating temperature or the operating pressure of the fuel cell can be predetermined with the device outlined above.

In the invention, to achieve intensive mixing of fuel and water at temperatures and pressures which are above the boiling point of the fuel, the water is pumped through a porous body, e.g. a tube or a cylinder, with an at least partially porous wall. If, in the process, the fuel on one side of the porous body is pumped into the space at a defined flow rate, a slightly higher pressure is established in this fuel-filled space, and the fuel penetrates through the porous body over the entire porous surface area into the water flowing by on the other side of the porous body. The mixing in the edge regions and at the enlarged surface of the porous body advantageously prevents the undesirable bubble formation process.

In the invention, it is primarily important to use a porous body with suitably large pores and therefore to increase the surface area for intimate mixing of water and fuel. The enlarged surface area makes the intimate mixing and heat transfer faster than in previous methods, so that evaporation and therefore bubble formation no longer occurs in the meantime.

Other features which are considered as characteristic for the invention are set forth in the appended claims.

Although the invention is illustrated and described herein as embodied in a method for mixing fuel in water, associated device and use of this device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic cross section through a first device according to the invention for mixing water and fuel; and

FIG. 2 is a diagrammatic cross section through a second exemplary embodiment of the device according to the invention for mixing water and fuel.

### DESCRIPTION OF THE PREFERRED EMBODIMENTS

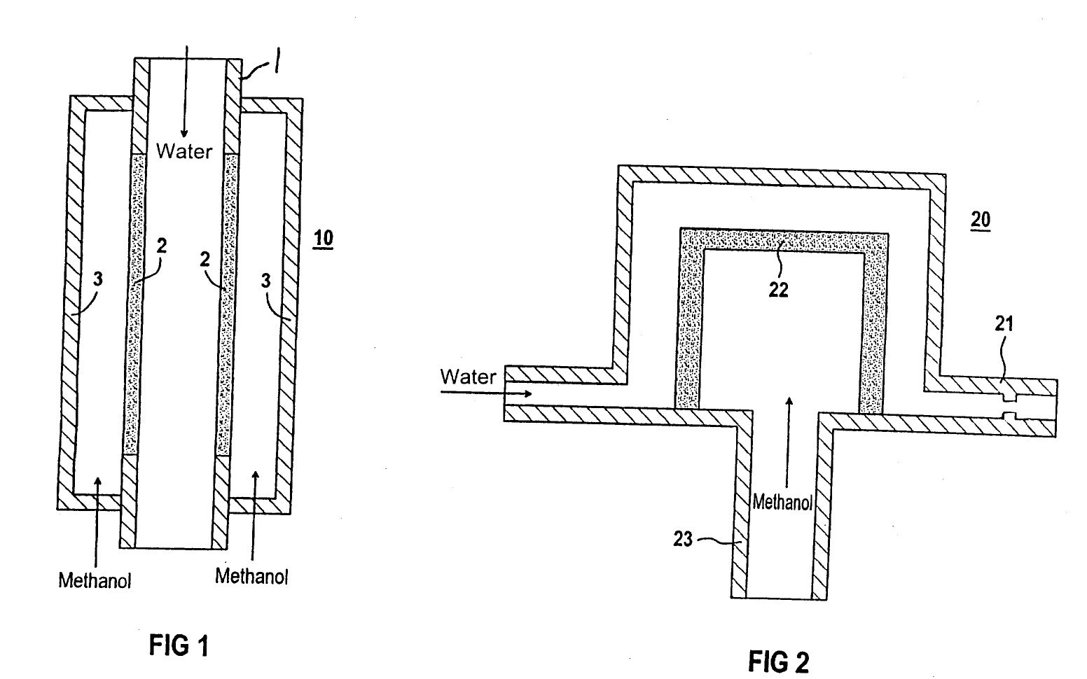

Referring now to the figures of the drawing in detail and first, particularly, to FIG. 1 thereof, there is shown a fuel/water mixer, with methanol as the fuel. FIG. 1 shows a double-tube configuration 10.

The mixing configuration comprises an inner tube 1, through which water flows. In a defined region 2 of the tube body, the inner tube 1 is formed by a porous material. The porosity of the porous material is such that water cannot pass through from the inside outward but other fluids can pass inward. In the region of the tube wall of the porous body 2, an outer tube 3, into which methanol is pumped at a defined flow rate, is arranged around the inner tube 1. As a result, a slightly higher pressure is established in the methanol-filled space, and the methanol can penetrate through the porous wall of the tube body 2 and penetrate into the water flowing by on the other side of the porous body 2 over the entire porous area. The result is that a mixture of methanol and water is formed in the wall regions. A process whereby bubbles are formed is prevented on account of the enlarged surface area of the wall of the porous body 2.

FIG. 2 shows a cylinder configuration 20, which comprises an outer passage 21, through which water is pumped. An inner cylinder 22, which comprises a porous wall, juts into the cylinder 21. Methanol is pumped into the inner cylinder 22 through a fuel feed line 23. The same effect as in FIG. 1, whereby the methanol can penetrate through the porous wall into the water passage and a water/methanol mixture is formed, occurs.

In FIG. 1, the methanol penetrates into the edge region of the flow of water present in the tube 1 all the way around the circumference of the tube wall 2, while in FIG. 2 only the edge region of the flow of water which faces the cylinder 22 is acted on by methanol. Since the edge regions of the volumetric flow in the following tube section have a higher methanol concentration than the center of the volumetric flow, it is recommended that a subsequent narrow point, e.g., a constriction formed by a smaller diameter tube or mixing baffles or the like, of less than ⅓ of the tube diameter be arranged in the tube 1 or 21, resulting in a turbulent flow with thorough mixing. The constriction is diagrammatically illustrated to the right of the tube 21.

Porous bodies which can be used include a ceramic tube, a metallic gas filter, glass material, or commercial glass or ceramic filters. These materials are available with a defined pore diameter. The pore diameter should be smaller than 10 μm but greater than 0.2 μm, so that the dynamic pressure does not become too high for the methanol pump.

As part of the presetting of the pore size, it is also possible to set the desired operating temperature/operating pressure of an installation. Small pores should be used for high temperatures and low pressures, while larger pores should be used for high pressures and lower temperatures.

A device as shown in FIG. 2 was tested in combination with a direct methanol fuel cell (DMFC). The application was suitable in particular when the operating temperatures of the DMFC were above the boiling point of methanol. Therefore, the operating temperature or operating pressure of the DMFC can be predetermined in a suitable way by suitable selection of the pore size of the porous materials used in the above examples.

The solution to the problem described above with reference to a DMFC operated with methanol as fuel, can also be transferred to fuel cells which are operated with different fuels.

The invention described herein is advantageously integrated in fuel cell systems as they are described in my copending, concurrently filed patent applications PCT/DE01/02981, PCT/DE01/02980, PCT/DE01/02910, PCT/DE01/02905, and PCT/DE01/02976, the disclosures of which are herewith incorporated by reference.

I claim:

1. A mixing method, which comprises the following steps:
pumping water through a hollow body having a porous wall formed of porous material, at least in certain regions thereof;
pumping a fuel at a defined flow rate into a space on a side of the porous wall opposite from the water;
wherein a pressure difference between the two sides of the porous wall causes the fuel to penetrate into the water on the opposite side of the porous wall substantially over an entire surface area of the porous wall; and
producing a homogenous mixture of water and fuel substantially without bubble formation.

2. The method according to claim 1 in combination with a fuel cell for mixing a fuel for the fuel cell.

3. The method according to claim 1, wherein the fuel is methanol.

4. The method according to claim 3, which comprises pumping the mixture of water and methanol through a constriction for generating a turbulent flow and improving an intimate mixing of the mixture.

5. The method according to claim 3, which comprises adjusting one of a temperature and a pressure of the methanol/water mixture by predetermining a pore size of the porous material.

6. The method according to claim 5, which comprises selecting small pores for high temperatures and low pressures of the methanol/water mixture and selecting large pores for high pressures and low temperatures of the methanol/water mixture.

7. A device for mixing a fuel and water, comprising:
a hollow body formed with an inside for receiving and having water pumped therethrough, said hollow body being formed, at least in a part thereof, with a porous wall; and
a further wall externally delimiting a region of the porous wall and forming a closed space fluidically communicating with the inside of said hollow body through the porous wall.

8. The device according to claim 7 configured to mix a fuel and water with the method according to claim 1.

9. The device according to claim 7, wherein said porous wall has a porosity greater than 0.1 μm.

10. The device according to claim 7, wherein said porous wall has a porosity with pores between 0.2 μm and 10 μm.

11. The device according to claim 7, wherein said hollow body with said porous wall is a tube.

12. The device according to claim 7, wherein said hollow body with said porous wall is a cylinder.

13. The device according to claim 11, wherein said porous wall is a ceramic tube segment forming a part of said tube.

14. The device according to claim 7, wherein said porous wall is at least one member selected from the group consisting of a metallic glass filter, a wall consisting of glass material, a wall containing glass filters, and a wall containing ceramic filters.

15. In combination with a fuel cell operated at temperatures higher than a boiling point of a fuel thereof, the method according to claim 1 for mixing the fuel with water.

16. The device according to claim 7 connected in a fuel circuit of a fuel cell operated at temperatures higher than a boiling point of a fuel thereof for mixing fuel with water.

17. The device according to claim 16, wherein the fuel is methanol and the fuel cell is a direct methanol fuel cell.

18. The combination according to claim 15, which comprises setting one of an operating temperature and an operating pressure of the fuel cell by mixing the fuel and the water in the device according to claim 7.
